(19) United States
(12) Patent Application Publication
(10) Pub. No.: US 2026/0349693 A1
(43) Pub. Date: Nov. 5, 2026

(54) DETECTION OF LOOP-CARRIED FALSE DEPENDENCIES

(71) Applicant: Intel Products IP LLC, Santa Clara, CA (US)

(72) Inventors: Tianqing WANG, Folsom, CA (US); Wei XIAO, Shanghai (CN)

(21) Appl. No.: 19/713,785

(22) Filed: Jun. 19, 2026

(30) Foreign Application Priority Data
Mar. 20, 2026 (WO) PCT/CN2026/084817

(51) Int. Cl. G06F 8/41

(52) U.S. Cl. CPC G06F 8/433; G06F 8/452

(57) ABSTRACT

Various aspects relate to heuristic-based detection of loop-carried false dependency bottlenecks in compiled binaries. Execution profile data is used to identify a hot loop in a compiled binary. An inter-procedural control flow graph is constructed for the hot loop by inlining callee function code. Two data dependency graphs are built from the inter-procedural control flow graph: a first graph that preserves architectural dependencies, including potential false dependencies, and a second graph that excludes at least one potential false dependency edge. A longest loop-carried dependency chain is determined for the first graph and for the second graph, including by identifying strongly connected components and pruning nodes that do not belong to a strongly connected component containing at least two nodes. The chains are compared to identify a false dependency bottleneck of the hot loop.

### CROSS-REFERENCE TO RELATED APPLICATIONS

This application claims the benefit of International Application No. PCT/CN2026/084817, filed Mar. 20, 2026, the contents of which are incorporated herein by reference in their entirety.

### BACKGROUND

Certain x86 instructions carry dependencies that are architecturally required but semantically irrelevant to common use cases in software. For example, an instruction that converts a value from a source operand and merges the result into a destination register architecturally depends on the prior contents of the destination register, even when the merged content is never consumed. Such a false dependency can form a loop-carried dependency chain that becomes the critical path of a loop, creating a severe and difficult-to-detect limit on instruction-level parallelism.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the proposed configuration. In the following description, various aspects are described with reference to the following drawings, in which:

FIG. 1 shows an example inter-procedural control flow graph constructed for a hot loop that includes an inlined callee function, in various aspects;

FIG. 2 shows an example data dependency graph that includes a false dependency edge, in various aspects;

FIG. 3 shows an example data dependency graph that excludes a potential false dependency edge, in various aspects;

FIG. 4 shows an example of strongly connected components identified in an original data dependency graph that preserves false dependency edges, in various aspects; and

FIG. 5 shows another example of strongly connected components identified in an optimized data dependency graph that excludes false dependency edges, in various aspects.

### DESCRIPTION

The following detailed description refers to the accompanying drawings that show, by way of illustration, specific details and aspects in which the proposed configuration may be practiced. These aspects are described in sufficient detail to enable those skilled in the art to practice the proposed configuration. Other aspects may be utilized and structural, logical, and electrical changes may be made without departing from the scope of the proposed configuration. The various aspects are not necessarily mutually exclusive, as some aspects may be combined with one or more other aspects to form new aspects. Various aspects are described in connection with methods and various aspects are described in connection with devices (e.g., a memory module, a computing system). However, it is understood that aspects described in connection with methods may apply in a corresponding manner to the devices, and vice versa.

The present teachings describe an automated, profile-guided analysis workflow that identifies potential performance bottlenecks caused by false dependencies in compiled binary code. A false dependency, as used herein, refers to an architectural dependency of an instruction on an operand whose value is not semantically relevant to the computation performed by the instruction. For example, an instruction that converts a value from a source operand and merges the result into a destination register has an architectural dependency on the prior contents of the destination register, even when the merge result is never consumed by subsequent instructions. Such false dependencies are sometimes referred to as partial-register dependencies or output dependencies and arise in a variety of microprocessor instructions including, for example, scalar conversion instructions (e.g., VCVTSI2SS, VCVTSI2SD), scalar insertion instructions, and partial-register write instructions. As an illustrative example, the instruction VCVTSI2SS xmm1, xmm2, r32 converts an integer from the general-purpose register r32 into a single-precision floating-point value and merges the result with the upper 96 bits of the single instruction, multiple data (SIMD) register xmm2. The merge behavior with respect to xmm2 creates an architectural dependency on the prior value of xmm2, even though software rarely, if ever, relies on this merge semantics. A compiler may attempt to assign a clean (i.e., independently written) register to the merge operand so as to break the dependency, but success is not guaranteed, particularly when a function call boundary limits the visibility of the register allocator.

A corresponding analysis may involve constructing two versions of a data dependency graph (DDG) based on an inter-procedural control flow graph (CFG) of a loop under analysis. In various aspects, a first DDG may account for certain architectural dependencies, including potential false dependencies, and a second DDG excludes at least one dependency edge corresponding to a potential false dependency. Such an analysis then determines a longest loop-carried dependency chain in associated DDGs. False dependency bottlenecks may be identified by comparing the two dependency chains.

The present teachings address various challenges posed by false dependencies in various microprocessor instruction set architectures. Such false dependencies may repeatedly arise in performance-critical workloads and can be difficult to detect using conventional profiling tools because corresponding performance degradation manifests as a drop in performance with no clear indicator of a root cause. In practice, with respect to overall lower performance of loops, latency of a single loop iteration may be hard to measure and rarely matters, though in aggregate removing loop-carried false dependencies can significantly improve performance. Moreover, not every removal of an identified false dependency may end up remedying a significant performance bottleneck, due to various inaccuracies in a particular analysis. For example, not all stack accesses may be properly tracked. In practice, no harm is done because even in the presence of a false positive, the cost of removing an insignificant false dependency is small.

### Hot Loop Identification and Inter-Procedural Control Flow Graph Construction

In various aspects, the analysis begins by identifying hot loops in a compiled binary using execution profile data. Execution profile data may be obtained, for example, via hardware performance counters, instrumentation-based profiling, or sampling-based profiling. A loop may be identified as a hot loop when corresponding execution profile data indicates that the loop accounts for a significant portion of total execution time or executes a number of iterations that exceeds a configurable threshold.

In various aspects, for each hot loop, an inter-procedural control flow graph is constructed. If the loop body contains one or more function calls, the analysis may inline code corresponding to callee functions into the inter-procedural CFG. In various aspects, this inter-procedural treatment may be deemed important because compilers' false-dependency avoidance mechanisms may be subject to mischaracterization when a function call boundary is involved. In particular, a compiler performing register allocation within a callee function may not have visibility into various register states at the call site and may therefore be unable to select a clean register for an operand that introduces a false dependency.

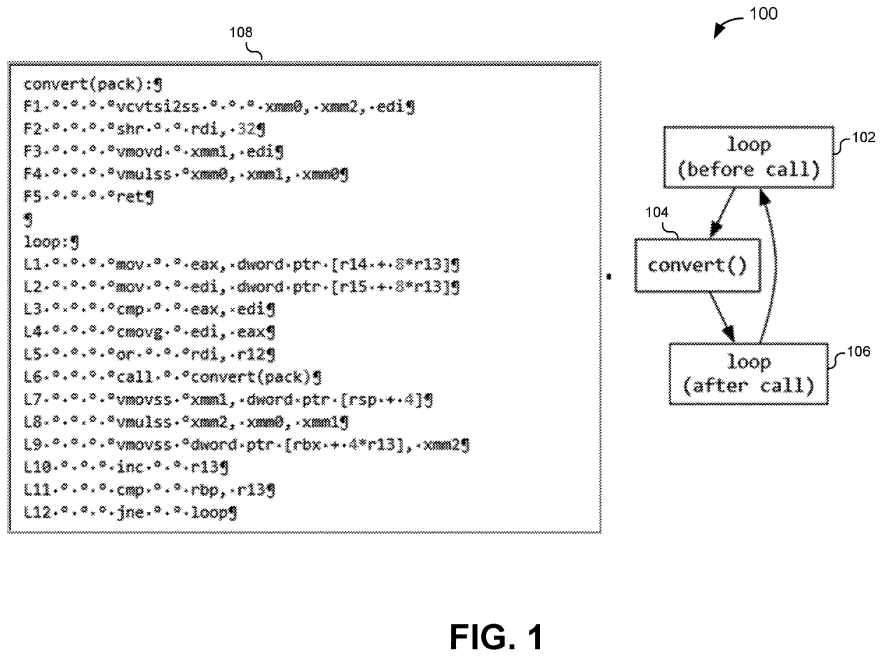

FIG. 1 shows an example inter-procedural control flow graph 100 constructed for a sample loop that calls a conversion function convert( ). The left portion of FIG. 1 shows the assembly-level instructions 108 of the loop body (instructions L1 to L12) and of the callee function (instructions F1 to F5). The right portion of FIG. 1 shows the resulting inter-procedural control flow graph 100, which includes a block 102 representing the portion of the loop body before the function call, a block 104 representing the inlined callee function convert( ), and a block 106 representing the portion of the loop body after the function call. Directed edges between the block 102, the block 104, and the block 106 represent the flow of control through a loop iteration, including the flow of control into the inlined callee function at the call site and back to the loop body upon return.

### Stack Pointer Tracking and Stack Reference Analysis

Because function calls typically involve passing data on a stack, various analyses consistent with the present teachings may track stack pointer and frame pointer movements throughout an inter-procedural CFG. Tracked values of such pointers may be used to resolve explicit stack references to corresponding stack slots. Explicit stack references may include, for example, push and pop instructions and memory accesses of the form [stack pointer register (RSP)+offset] or [base pointer register (RBP)+offset], for example. Other potential stack accesses, such as indexed accesses or accesses through registers other than the stack pointer or frame pointer, may be conservatively ignored to avoid introducing inaccurate dependency information.

In the example of FIG. 1, a call instruction (L6) and a return instruction (F5) both read and modify the stack pointer RSP. Instruction L7 reads from the stack through an RSP-relative reference, but no other direct write to the stack is present within the loop body. Accordingly, the analysis treats the memory location referenced by instruction L7 as storing an external value on which the loop depends.

### Data Dependency Graph Construction

In various aspects, an analysis consistent with the present teachings may perform a reaching definition analysis on an inter-procedural control flow graph to determine associated data dependencies among instructions in a particular loop. Based on corresponding results associated with the reaching definition analysis, an illustrative system may construct data dependency graphs (DDGs) for an associated inter-procedural CFG.

In various aspects, for each hot loop, two DDGs may be constructed. A first data dependency graph (DDGorig) preserves associated architectural dependencies, including false dependencies. A second data dependency graph (DDGopt) excludes at least one dependency edge corresponding to a potential false dependency. By comparing the two DDGs, the analysis can isolate the performance impact attributable to false dependencies.

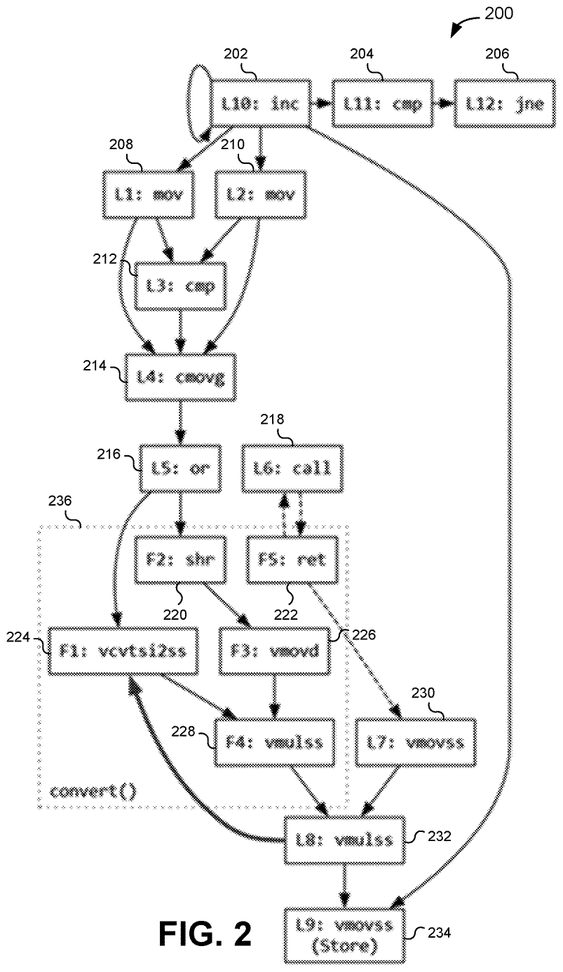

FIG. 2 shows an example data dependency graph 200 that includes a potential false dependency edge. The data dependency graph 200 includes nodes representing respective instructions of the hot loop and of the inlined callee function. A node 202, a node 204, and a node 206 represent the loop-control instructions L10 (inc), L11 (cmp), and L12 (jne), respectively. A node 208 and a node 210 represent the load instructions L1 and L2, respectively. A node 212, a node 214, and a node 216 represent the instructions L3 (cmp), L4 (cmovg), and L5 (or), respectively. A node 218 represents the call instruction L6. A node 220, a node 222, a node 224, a node 226, and a node 228 represent the callee instructions F2 (shr), F5 (ret), F1 (vcvtsi2ss), F3 (vmovd), and F4 (vmulss), respectively. A node 230 represents the stack-load instruction L7, a node 232 represents the multiply instruction L8, and a node 234 represents the store instruction L9. A boundary 236 encloses the nodes corresponding to the inlined callee function convert( ).

In FIG. 2, solid directed edges represent true data dependencies, and dashed directed edges represent dependencies through the stack pointer register. An emphasized edge from the node 232 to the node 224 represents the potential false dependency edge, corresponding to the architectural dependency of the conversion instruction F1 on the merge operand xmm2, which is written by the multiply instruction L8 of a preceding loop iteration.

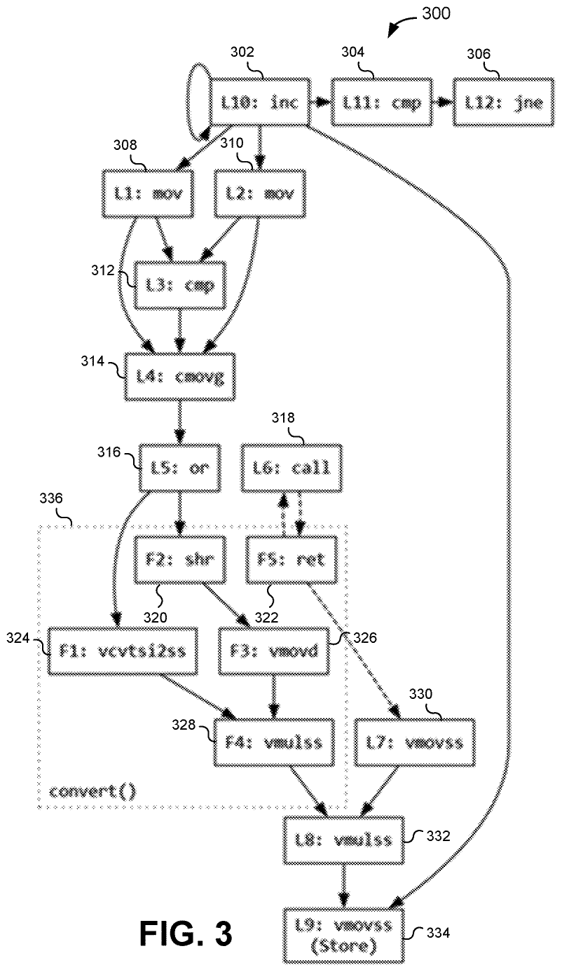

FIG. 3 shows a corresponding data dependency graph 300 in which the potential false dependency edge has been removed. In FIG. 3, a node 302, a node 304, a node 306, a node 308, a node 310, a node 312, a node 314, a node 316, and a node 318 represent the instructions L10, L11, L12, L1, L2, L3, L4, L5, and L6, respectively, and correspond to the node 202, the node 204, the node 206, the node 208, the node 210, the node 212, the node 214, the node 216, and the node 218 of FIG. 2, respectively. A node 320, a node 322, and a node 324 represent the callee instructions F2, F5, and F1, respectively, and correspond to the node 220, the node 222, and the node 224, as in FIG. 2. A node 326 and a node 328 represent the callee instructions F3 and F4, respectively. A node 330, a node 332, and a node 334 represent the instructions L7, L8, and L9, respectively, and a boundary 336 encloses the nodes corresponding to the inlined callee function convert( ). The data dependency graph 300 omits the potential false dependency edge between the node 332 and the node 324, but otherwise includes the true data dependencies and the stack pointer dependencies of the data dependency graph 200 of FIG. 2 above.

### Longest Loop-Carried Dependency Chain Search

In various aspects, if a loop is bottlenecked by a false dependency, the false dependency may appear in the loop's longest loop-carried dependency chain. The longest loop-carried dependency chain can be computed from the DDG; however, finding the longest path in a general graph is a nondeterministic polynomial (NP)-hard problem. To make the search tractable, an illustrative analysis may first identify strongly connected components (SCCs) in the DDG and then prune associated nodes that do not participate in an SCC of size greater than or equal to two (i.e., an SCC containing at least two nodes). A backtracking search may then be performed on the remaining nodes to find a longest path, which corresponds to the longest loop-carried dependency chain. Because two DDGs may be constructed for each hot loop, the search yields two corresponding dependency chains: a first chain (Corig) derived from DDGorig and a second chain (Copt) derived from DDGopt. In various aspects, the same identification of strongly connected components, pruning, and backtracking search may be applied to the first data dependency graph and to the second data dependency graph, such that the first chain is the longest loop-carried dependency chain of the first data dependency graph and the second chain is a longest-loop carried dependency chain of the second data dependency graph.

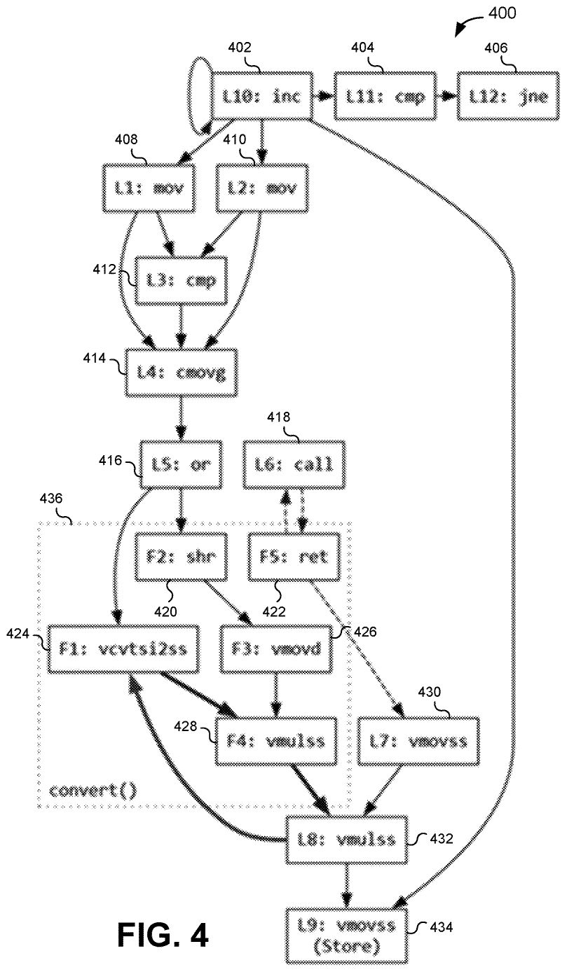

FIG. 4 shows the strongly connected components identified in an original data dependency graph 400 (i.e., a data dependency graph, such as the data dependency graph 200 of FIG. 2, that preserves the potential false dependency edge). In FIG. 4, a node 402, a node 404, a node 406, a node 408, a node 410, a node 412, a node 414, a node 416, and a node 418 represent the instructions L10, L11, L12, L1, L2, L3, L4, L5, and L6, respectively. A node 420, a node 422, a node 424, a node 426, and a node 428 represent the callee instructions F2, F5, F1, F3, and F4, respectively. A node 430, a node 432, and a node 434 represent the instructions L7, L8, and L9, respectively, and a boundary 436 encloses the nodes corresponding to the inlined callee function convert( ).

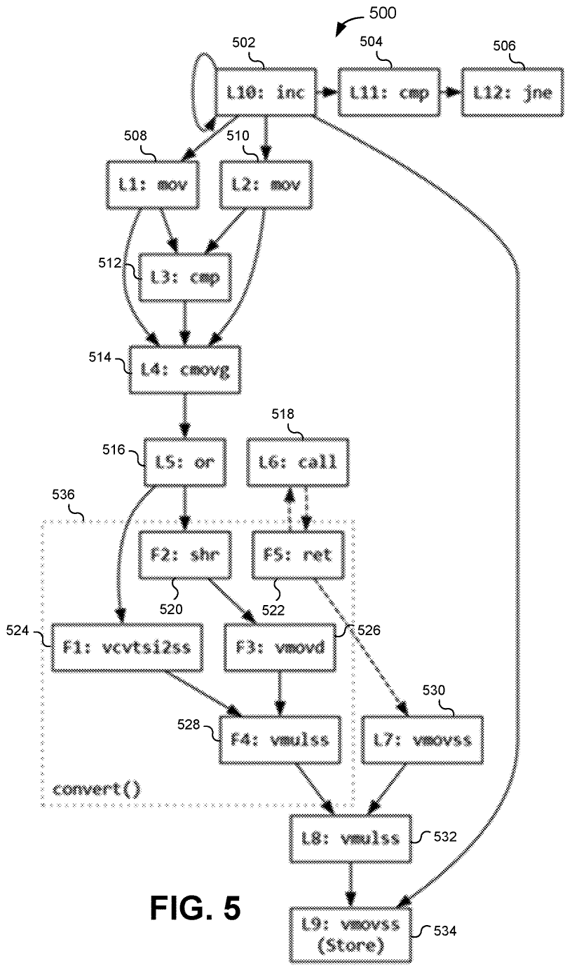

FIG. 5 shows the strongly connected components identified in an optimized data dependency graph 500 (i.e., a data dependency graph, such as the data dependency graph 300 of FIG. 3, that excludes the potential false dependency edge). In FIG. 5, a node 502, a node 504, a node 506, a node 508, a node 510, a node 512, a node 514, a node 516, and a node 518 represent the instructions L10, L11, L12, L1, L2, L3, L4, L5, and L6, respectively. A node 520, a node 522, a node 524, a node 526, and a node 528 represent the callee instructions F2, F5, F1, F3, and F4, respectively. A node 530, a node 532, and a node 534 represent the instructions L7, L8, and L9, respectively, and a boundary 536 encloses the nodes corresponding to the inlined callee function convert( ).

In the illustrated example, there are two true loop-carried dependency chains, indicated by highlighted edges in FIG. 4 and FIG. 5. One true chain corresponds to the increment of the loop induction variable R13 via the instruction L10, represented by the node 402 in FIG. 4 and by the node 502 in FIG. 5. Another true chain corresponds to the stack pointer dependency through the call instruction L6 and the return instruction F5, represented by the node 418 and the node 422 in FIG. 4 and by the node 518 and the node 522 in FIG. 5; this chain forms the longest loop-carried dependency chain of the optimized data dependency graph 500. The original data dependency graph 400, however, additionally includes a false loop-carried dependency chain that traverses the conversion instruction F1, the multiply instruction F4, and the multiply instruction L8, represented by the node 424, the node 428, and the node 432, respectively. This false chain is the longest loop-carried dependency chain of the original data dependency graph 400 in terms of both the number of instructions and the total execution latency.

### Result Analysis

In various aspects the two resulting dependency chains may be analyzed to identify potential false dependency bottlenecks. In various aspects, important indicators that a false dependency likely extends the critical path of the loop and constitutes a potential bottleneck include one or more of the following: The length and total latency of Corig are significantly greater than the length and total latency of Copt. Corig traverses through an operand that is commonly associated with false dependencies (e.g., the merge operand of a scalar conversion instruction). Corig involves significantly more memory operations than Copt.

Such an analysis may be heuristic in nature. Accordingly, it is possible for the analysis to produce false positives, in which a flagged site is not an actual performance bottleneck, and false negatives, in which a genuine false dependency bottleneck is not discovered. In some aspects, the analysis may apply configurable thresholds for the difference in chain length or latency to tune the tradeoff between false positives and false negatives.

In the example, because the longest dependency chain in DDGorig is significantly longer than the longest dependency chain in DDGopt, and because one of the dependency edges in Corig passes through the second operand (xmm2) of the vcvtsi2ss instruction, the analysis determines that this edge may represent a false dependency that hinders performance. A binary optimization tool or recompilation system may then act on this determination by, for example, inserting an instruction to clear the merge operand before the vcvtsi2ss instruction, thereby breaking the false dependency chain. In various aspects, the transformation may be applied when the false dependency is on the loop-carried dependency chain. If the false dependency is not on the critical path, no optimization need be performed.

The analyses described herein may be implemented by a binary analysis apparatus, e.g., a computing system that includes a memory and a processor coupled to the memory, the memory storing instructions executable by the processor to carry out any of the analyses described herein. The analyses may also be implemented, in whole or in part, by a binary analysis circuit, which may include any of the processor implementations described further below. In various aspects, the analyses described herein may be integrated into a binary optimization tool, a dynamic binary translation system, a compiler toolchain, or a performance analysis tool. For example, a binary translation system supporting translation of a compiled binary based on runtime profile data may apply the analyses described herein to identify a false dependency bottleneck and may modify the compiled binary, e.g., during translation, to break the identified false dependency bottleneck.

A binary analysis apparatus as described herein may be made by a process that includes providing a memory, storing in the memory instructions executable to carry out any of the analyses described herein, and coupling the memory to a processor configured to execute the instructions. The stored instructions may include instructions executable to modify a compiled binary conditionally, e.g., only when an identified false dependency is on a loop-carried dependency chain of a hot loop, such that no modification is applied when the identified false dependency is not on a critical path of the hot loop.

Unless explicitly specified, the term “transmit” encompasses both direct (point-to-point) and indirect transmission (via one or more intermediary points). Similarly, the term “receive” encompasses both direct and indirect reception.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “at least one” and “one or more” may be understood to include any integer number greater than or equal to one, i.e., one, two, three, four, [. . . ], etc. The term “a plurality” or “a multiplicity” may be understood to include any integer number greater than or equal to two, i.e. two, three, four, five, [. . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The term “processor” as used herein may be understood as any kind of technological entity that allows handling of data. The data may be handled according to one or more specific functions that the processor executes. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The following examples pertain to further aspects of this disclosure.

Example 1 is a method comprising: identifying, based at least in part on execution profile data for a compiled binary, a hot loop in the compiled binary; constructing a first data dependency graph of the hot loop that includes a dependency edge corresponding to a potential false dependency of an instruction of the hot loop and a second data dependency graph of the hot loop that excludes the dependency edge; and identifying, based at least in part on a comparison of the first data dependency graph and the second data dependency graph, a false dependency bottleneck of the hot loop.

Example 2 is the method of Example 1, wherein the comparison of the first data dependency graph and the second data dependency graph comprises: determining a first loop-carried dependency chain from the first data dependency graph and a second loop-carried dependency chain from the second data dependency graph; and comparing the first loop-carried dependency chain and the second loop-carried dependency chain.

Example 3 is the method of Example 1 or 2, further comprising constructing an inter-procedural control flow graph of the hot loop, the inter-procedural control flow graph comprising an inlined representation of a callee function invoked within the hot loop, wherein the first data dependency graph and the second data dependency graph are constructed based at least in part on the inter-procedural control flow graph.

Example 4 is the method of any one of Examples 1 to 3, wherein the execution profile data comprises at least one of hardware performance counter data, sampling-based profile data, or instrumentation-based profile data.

Example 5 is the method of any one of Examples 1 to 4, wherein identifying the hot loop comprises determining, based at least in part on the execution profile data, that the hot loop accounts for at least a predefined portion of an execution time of the compiled binary or that a number of iterations of the hot loop exceeds a threshold.

Example 6 is the method of any one of Examples 3 to 5, further comprising tracking a stack pointer value and a frame pointer value through the inter-procedural control flow graph.

Example 7 is the method of Example 6, further comprising resolving an explicit stack reference of the hot loop to a stack slot based at least in part on the stack pointer value or the frame pointer value, wherein the explicit stack reference comprises a push instruction, a pop instruction, or a memory access relative to a stack pointer register or a frame pointer register.

Example 8 is the method of Example 6 or 7, wherein a stack access through a register other than a stack pointer register or a frame pointer register is disregarded in constructing the first data dependency graph and the second data dependency graph.

Example 9 is the method of any one of Examples 3 to 8, wherein constructing the first data dependency graph and the second data dependency graph comprises performing a reaching definition analysis on the inter-procedural control flow graph.

Example 10 is the method of any one of Examples 2 to 9, wherein determining the first loop-carried dependency chain comprises identifying a plurality of strongly connected components of the first data dependency graph, pruning a node of the first data dependency graph that does not belong to a strongly connected component containing at least two nodes, and performing a backtracking search on one or more remaining nodes of the first data dependency graph.

Example 11 is the method of any one of Examples 2 to 10, wherein the first loop-carried dependency chain is a longest loop-carried dependency chain of the first data dependency graph and the second loop-carried dependency chain is a longest loop-carried dependency chain of the second data dependency graph.

Example 12 is the method of any one of Examples 2 to 11, wherein comparing the first loop-carried dependency chain and the second loop-carried dependency chain comprises at least one of: comparing a length or a latency of the first loop-carried dependency chain with a length or a latency of the second loop-carried dependency chain; determining whether the first loop-carried dependency chain traverses an operand associated with false dependencies; or comparing a number of memory operations of the first loop-carried dependency chain with a number of memory operations of the second loop-carried dependency chain.

Example 13 is the method of any one of Examples 1 to 12, wherein the potential false dependency comprises an architectural dependency of the instruction on an operand whose value is not semantically relevant to a computation performed by the instruction.

Example 14 is the method of any one of Examples 1 to 13, wherein the potential false dependency comprises a dependency on a merge operand of a scalar conversion instruction.

Example 15 is the method of any one of Examples 1 to 14, further comprising modifying the compiled binary to break the false dependency bottleneck.

Example 16 is the method of Example 15, wherein modifying the compiled binary comprises inserting, into the compiled binary, an instruction that clears an operand associated with the false dependency bottleneck.

Example 17 is the method of Example 15 or 16, wherein the compiled binary is modified in response to a determination that the false dependency bottleneck is on a loop-carried dependency chain of the hot loop, and is left unmodified otherwise.

Example 18 is an apparatus comprising a memory and a processor coupled to the memory, the processor configured to perform the method of any one of Examples 1 to 17.

Example 19 is the apparatus of Example 18, wherein the apparatus is included in a binary translation system configured to translate the compiled binary at runtime based at least in part on the execution profile data.

Example 20 is an apparatus comprising a binary analysis circuit for carrying out the method of any one of Examples 1 to 17.

Example 21 is machine-readable storage including machine-readable instructions that, when executed by a processor, cause the processor to carry out the method of any one of Examples 1 to 17.

Example 22 is a computer program comprising instructions which, when the program is executed by a processor, cause the processor to carry out the method of any one of Examples 1 to 17.

Example 23 is a process comprising: providing a memory; storing, in the memory, instructions executable to carry out the method of any one of Examples 1 to 17; and coupling the memory to a processor configured to execute the instructions.

What is claimed is:

1. An apparatus comprising:
a memory; and
a processor coupled to the memory, the processor adaptable to:
identify, based at least in part on execution profile data for a compiled binary, a hot loop in the compiled binary;
construct a first data dependency graph of the hot loop that includes a dependency edge corresponding to a potential false dependency of an instruction of the hot loop and a second data dependency graph of the hot loop that excludes the dependency edge;
determine a first loop-carried dependency chain from the first data dependency graph and a second loop-carried dependency chain from the second data dependency graph; and
identify, based at least in part on a comparison of the first loop-carried dependency chain and the second loop-carried dependency chain, a false dependency bottleneck of the hot loop.

2. The apparatus of claim 1, wherein the processor is further adaptable to construct an inter-procedural control flow graph of the hot loop, the inter-procedural control flow graph comprising an inlined representation of a callee function invoked within the hot loop, and wherein the processor is adaptable to construct the first data dependency graph and the second data dependency graph based at least in part on the inter-procedural control flow graph.

3. The apparatus of claim 2, wherein the processor is further adaptable to track a stack pointer value and a frame pointer value through the inter-procedural control flow graph and to resolve a stack reference of the hot loop to a stack slot based at least in part on the stack pointer value or the frame pointer value.

4. The apparatus of claim 2, wherein the processor is adaptable to construct the first data dependency graph and the second data dependency graph based at least in part on a reaching definition analysis performed on the inter-procedural control flow graph.

5. The apparatus of claim 1, wherein the first loop-carried dependency chain is a longest loop-carried dependency chain of the first data dependency graph and the second loop-carried dependency chain is a longest loop-carried dependency chain of the second data dependency graph.

6. The apparatus of claim 1, wherein, to determine the first loop-carried dependency chain, the processor is adaptable to identify a plurality of strongly connected components of the first data dependency graph, prune a node of the first data dependency graph that does not belong to a strongly connected component containing at least two nodes, and perform a backtracking search on one or more remaining nodes of the first data dependency graph.

7. The apparatus of claim 1, wherein the processor is further adaptable to modify the compiled binary to break the false dependency bottleneck.

8. A method comprising:
identifying, based at least in part on execution profile data for a compiled binary, a hot loop in the compiled binary;
constructing a first data dependency graph of the hot loop that includes a dependency edge corresponding to a potential false dependency of an instruction of the hot loop and a second data dependency graph of the hot loop that excludes the dependency edge;
determining a first loop-carried dependency chain from the first data dependency graph and a second loop-carried dependency chain from the second data dependency graph; and
identifying, based at least in part on a comparison of the first loop-carried dependency chain and the second loop-carried dependency chain, a false dependency bottleneck of the hot loop.

9. The method of claim 8, further comprising constructing an inter-procedural control flow graph of the hot loop, the inter-procedural control flow graph comprising an inlined representation of a callee function invoked within the hot loop, wherein the first data dependency graph and the second data dependency graph are constructed based at least in part on the inter-procedural control flow graph.

10. The method of claim 9, further comprising: tracking a stack pointer value and a frame pointer value through the inter-procedural control flow graph; and resolving a stack reference of the hot loop to a stack slot based at least in part on the stack pointer value or the frame pointer value.

11. The method of claim 8, wherein the first loop-carried dependency chain is a longest loop-carried dependency chain of the first data dependency graph and the second loop-carried dependency chain is a longest loop-carried dependency chain of the second data dependency graph.

12. The method of claim 8, wherein determining the first loop-carried dependency chain comprises identifying a plurality of strongly connected components of the first data dependency graph, pruning a node of the first data dependency graph that does not belong to a strongly connected component containing at least two nodes, and performing a backtracking search on one or more remaining nodes of the first data dependency graph.

13. The method of claim 8, wherein the comparison comprises at least one of: a comparison of a length or a latency of the first loop-carried dependency chain with a length or a latency of the second loop-carried dependency chain; a determination of whether the first loop-carried dependency chain traverses an operand associated with false dependencies; or a comparison of a number of memory operations of the first loop-carried dependency chain with a number of memory operations of the second loop-carried dependency chain.

14. The method of claim 8, further comprising modifying the compiled binary to break the false dependency bottleneck, wherein modifying the compiled binary comprises inserting, into the compiled binary, an instruction that clears an operand associated with the false dependency bottleneck.

15. A non-transitory machine-readable storage medium storing instructions that, when executed by a processor, cause the processor to:
identify, based at least in part on execution profile data for a compiled binary, a hot loop in the compiled binary;
construct a first data dependency graph of the hot loop that includes a dependency edge corresponding to a potential false dependency of an instruction of the hot loop and a second data dependency graph of the hot loop that excludes the dependency edge;
determine a first loop-carried dependency chain from the first data dependency graph and a second loop-carried dependency chain from the second data dependency graph; and
identify, based at least in part on a comparison of the first loop-carried dependency chain and the second loop-carried dependency chain, a false dependency bottleneck of the hot loop.

16. The non-transitory machine-readable storage medium of claim 15, wherein the instructions, when executed, further cause the processor to construct an inter-procedural control flow graph of the hot loop, the inter-procedural control flow graph comprising an inlined representation of a callee function invoked within the hot loop, and to construct the first data dependency graph and the second data dependency graph based at least in part on the inter-procedural control flow graph.

17. The non-transitory machine-readable storage medium of claim 15, wherein the first loop-carried dependency chain is a longest loop-carried dependency chain of the first data dependency graph and the second loop-carried dependency chain is a longest loop-carried dependency chain of the second data dependency graph.

18. The non-transitory machine-readable storage medium of claim 15, wherein the instructions, when executed, cause the processor to determine the first loop-carried dependency chain by identifying a plurality of strongly connected components of the first data dependency graph, pruning a node of the first data dependency graph that does not belong to a strongly connected component containing at least two nodes, and performing a backtracking search on one or more remaining nodes of the first data dependency graph.

19. The non-transitory machine-readable storage medium of claim 15, wherein the comparison comprises at least one of: a comparison of a length or a latency of the first loop-carried dependency chain with a length or a latency of the second loop-carried dependency chain; a determination of whether the first loop-carried dependency chain traverses an operand associated with false dependencies; or a comparison of a number of memory operations of the first loop-carried dependency chain with a number of memory operations of the second loop-carried dependency chain.

20. The non-transitory machine-readable storage medium of claim 15, wherein the instructions, when executed, further cause the processor to insert, into the compiled binary, an instruction that clears an operand associated with the false dependency bottleneck.
